(19) United States
(12) Patent Application Publication
(10) Pub. No.: US 2009/0302628 A1
(43) Pub. Date: Dec. 10, 2009

(54) MECHANISM TO DAMPER SPEED IN A CUPHOLDER AND CLOSE ASHCUP LID

(76) Inventor: Omar Cinco, Farmington Hills, MI (US)

Correspondence Address: FRASER CLEMENS MARTIN & MILLER LLC, 28366 KENSINGTON LANE, PERRYSBURG, OH, 43551, US

(21) Appl. No.: 12/135,583

(22) Filed: Jun. 9, 2008

(51) Int. Cl. B60N 3/00; B60N 3/08; B60R 7/06; B60N 3/10

(52) U.S. Cl. 296/37.1; 296/37.9; 224/282; 296/37.12; 224/483

(57) ABSTRACT

An assembly for a vehicle convenience unit having a cupholder and storage container that facilitates a lid to one of engage and disengage the storage container when the convenience unit is pivoted, militating against container spillage, by the use of a damping link arm. The assembly comprises a housing, a hinged convenience unit, a storage container lid, and a link arm.

### FIELD OF THE INVENTION

The invention relates to vehicles and in particular to cupholders and storage containers for use by vehicle occupants in a vehicle interior.

### BACKGROUND OF THE INVENTION

Modern vehicles afford occupants many amenities to help one enjoy time spent traveling. Besides offering conveniences that aid an operator in driving, conveniences may offer a sense of comfort and luxury. Examples of these amenities are cupholders and containers arranged within the vehicle to accommodate the drinking, smoking and storage needs of the occupants. Incorporation of these conveniences into the vehicle may pose a challenge to a manufacturer.

Amenities added to vehicles must adequately serve the occupant needs, while remaining aesthetically pleasing at a minimal cost to the manufacturer. To meet these ends, movable cupholder and container devices have been integrated into the dash panel of vehicles using a minimum amount of components. A vehicle operator may use integrated conveniences while driving, requiring brief interaction with those conveniences. Accordingly, combining cupholders and a container into a movable convenience unit in a vehicle dash panel allows for quick access while driving, reduced cost to manufacturers, and a pleasing look to consumers.

U.S. Pat. No. 5,680,974 discloses a convenience unit assembly including a container for ashes adapted to be integrated into a vehicle console. This design allows cupholders and a container to be concealed within the console. Multiple operator movements are required to open the separate covers of the cupholders and container, increasing required driver interaction time. Accident risk is likely to be increased by increased driver interaction time. While aesthetically pleasing, the convenience unit requires a complex and expensive arrangement of gears, springs, and dampers.

U.S. Pat. No. 6,361,008 B1 discloses a vehicle cupholder assembly that is integrated into a dash panel and flips down for operator use. The assembly does not include a separate container with the cupholders. If the container is included in the flip down assembly, returning a flip down cupholder to a storage position is likely to spill the contents of the container. A spill of a container holding ashes spreads ash in the vehicle, soiling the vehicle interior to the dissent of the operator. Despite being relatively simple and well integrated into the vehicle dash, the cupholder assembly does not integrate a separate container, requiring a separate container to be mounted elsewhere.

U.S. Pat. No. 4,462,630 discloses an ashtray device which releases stored energy to open the ashtray for operator use. The ashtray device includes a rotary damping device to control the ashtray speed when released from a stored position. The rotary damping device prevents a forceful ejection of ashes from the ashtray that may occur with unrestrained speed. For the purpose of preventing ash ejection from ashtrays that open for operator use, damping of some sort is generally used. Despite being relatively simple and well integrated into the vehicle dash, the ashtray does not integrate a cupholder, requiring a separate cupholder mounted elsewhere.

It would be desirable to have an inexpensive flip down convenience unit integrated into a vehicle interior, the convenience unit including a storage container, wherein the storage container has a lid which militates against container spillage, and wherein the lid is actuated by a link arm which also provides a damping function during convenience unit opening, thereby militating against ejection of the container contents.

### SUMMARY OF THE INVENTION

Presently provided by the invention, a flip down convenience unit including a storage container, wherein the storage container has a lid which militates against container spillage, and wherein the lid is actuated by a link arm which also provides a damping function during convenience unit opening that is inexpensive and integrated into a vehicle interior has surprisingly been discovered.

In one embodiment, the convenience unit assembly for a vehicle comprises a convenience unit hingedly positioned within an interior of the vehicle including at least one cupholder and at least one storage container disposed therein, a lid hingedly disposed on the convenience unit, and a link arm having a first end hingedly attached to the convenience unit and a second end slidably disposed in an elongate aperture in the interior of the vehicle, the link arm contacting the lid to close the lid when the convenience unit is pivoted into a closed position and permit the lid to open when the convenience unit is pivoted into an open position.

In another embodiment, the convenience unit assembly for a vehicle comprises a housing configured to be disposed in an interior of a vehicle, the housing having an elongate aperture formed therein, a convenience unit hingedly positioned within the housing including at least one cupholder and at least one storage container disposed therein, a lid hingedly disposed on the convenience unit, and a link arm having a first end hingedly attached to the convenience unit and a second end slidably disposed in the elongate aperture in the housing, the link arm contacting the lid to close the lid when the convenience unit is pivoted into a closed position and permit the lid to open when the convenience unit is pivoted into an open position when the convenience unit is substantially in the open position.

In another embodiment, the convenience unit assembly for a vehicle comprises a housing configured to be disposed in an interior of the vehicle, the housing having an elongate aperture formed therein, a convenience unit hingedly positioned within the housing including at least one cupholder and at least one storage container disposed therein, a lid hingedly disposed on the convenience unit, and a link arm having a first end hingedly attached to the convenience unit and a second end slidably disposed in the elongate aperture in the housing acting to dampen the pivotal speed of the convenience unit, the link arm contacting the lid to close the lid when the convenience unit is pivoted into a closed position, wherein a point intermediate the attachment points of the link arm contacts the lid and permits the lid to open when the convenience unit is pivoted into an open position when the convenience unit is substantially in the open position.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is a perspective view of a convenience unit assembly for a vehicle including a housing, a convenience unit, a lid, and a link arm according to an embodiment of the invention.

FIG. 2 is a cross-sectional side view of the assembly illustrated in FIG. 1 taken along line 2-2 and showing the assembly in an open position.

FIG. 3 is a cross-sectional side view of the assembly illustrated in FIG. 1 taken along line 2-2 and showing the assembly in an intermediate position.

FIG. 4 is a cross-sectional side view of the assembly illustrated in FIG. 1 taken along line 2-2 and showing the assembly in an intermediate position.

FIG. 5 is a cross-sectional side view of the assembly illustrated in FIG. 1 taken along line 2-2 and showing the assembly in a closed position.

### DETAILED DESCRIPTION OF EXEMPLARY EMBODIMENTS OF THE INVENTION

The following detailed description and appended drawings describe and illustrate an exemplary embodiment of the present invention. The description and drawings serve to enable one skilled in the art to make and use the invention, and are not intended to limit the scope of the invention in any manner. It is understood that materials other than those described can be used without departing from the scope and spirit of the invention.

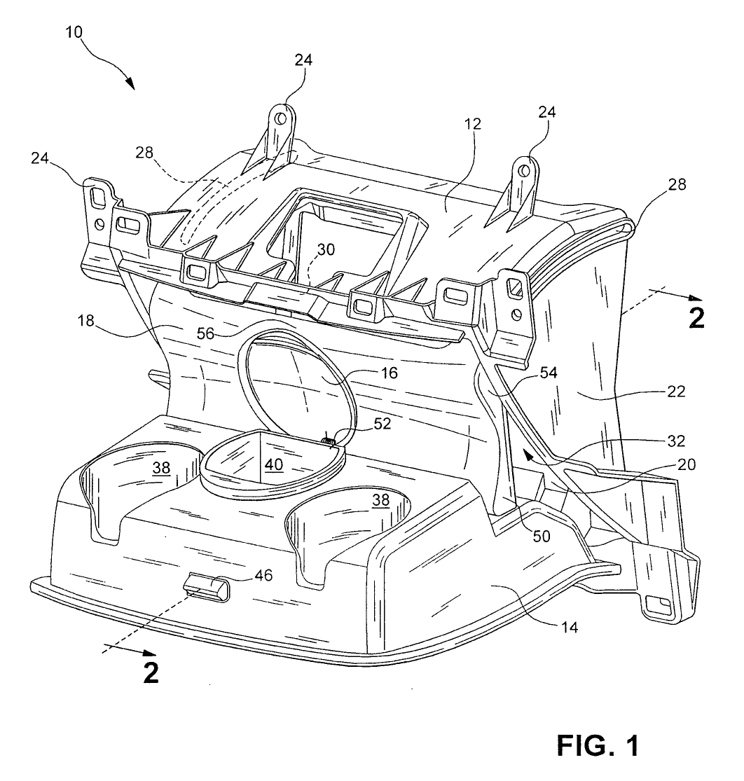

FIG. 1 illustrates a vehicle convenience unit assembly 10 according to an embodiment of the invention. The assembly 10 shown is disposed in a dash panel of a vehicle, although it is understood that the assembly can be disposed in other areas of an interior of the vehicle. The convenience unit assembly 10 includes a housing 12, a convenience unit 14, a lid 16, and a link arm 18.

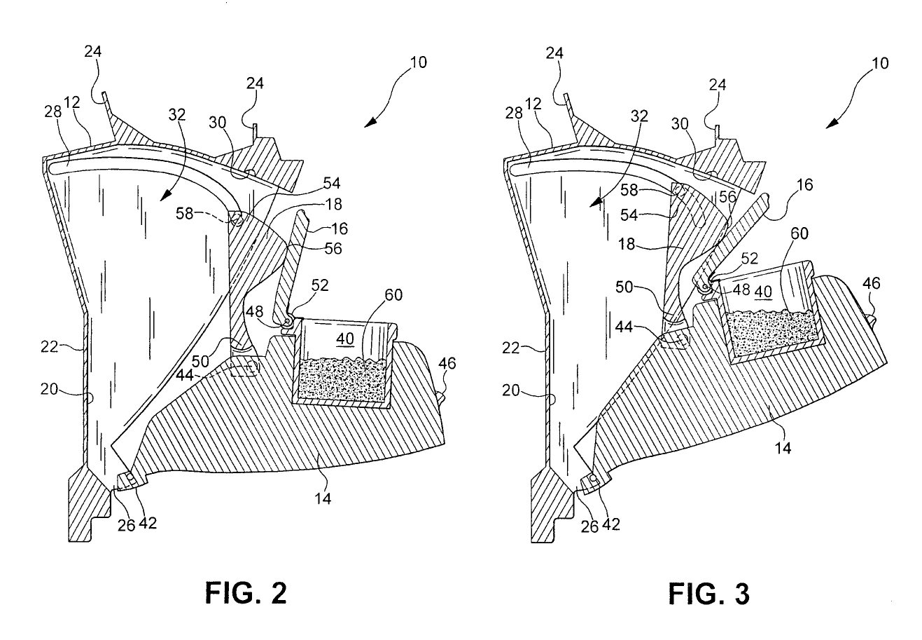

The housing 12 is typically made from a material such as plastic, and can be formed by any conventional means such as injection molding. The housing 12 has an inner side 20 and an outer side 22. The outer side 22 includes a plurality of fastening points 24. The fastening points 24 are adapted to be attached with corresponding fasteners to an interior panel of the vehicle, thereby concealing the outer side 22 from view by vehicle occupants. The inner side 20 of the housing 12 includes a hinge half 26, elongate apertures 28, a latch receiver 30, and a unit cavity 32. The hinge half 26, as illustrated in FIGS. 2 through 5, is shown as formed within the housing 12. However, it is understood the hinge half 26 may be separately produced and attached to the housing 12. The hinge half 26 serves as an attachment point for the convenience unit 14. The apertures 28 are formed on opposing sides of the housing 12 and serve as attachment points for the link arm 18 and guide the link arm 18 as the convenience unit 14 is moved into an open or closed position. The latch receiver 30 is shown as being integrally formed within the housing 12. However, it is understood the latch receiver 30 may be integrally formed within the convenience unit 14 and as a separate component. The inner side 20 forms the cavity 32 which is adapted to receive the pivoting convenience unit 14. Housing apertures may be incorporated into the housing 12, for the purpose of mounting bumpers. Bumpers placed on the housing 12 prevent the convenience unit 14 from noisily vibrating, and afford a secure fit between the convenience unit 14 and the housing 12.

The convenience unit 14 can be made from any conventional material such as plastic, and can be formed by any conventional means such as injection molding. The convenience unit 14 includes cupholders 38, a storage container 40, a hinge half 42, a link arm mount 44, and a latch 46. In the embodiment shown, one storage container 40 and two cupholders 38 are included. However, more storage containers 40 and cupholders 38 or fewer cupholders 38 can be used as desired. When in a closed position, the convenience unit 14 pivots into and substantially fills the unit cavity 32.

The cupholders 38 may be integrally formed as a part of the convenience unit 14 as shown in FIG. 1 or may be formed separately and secured within the unit 14 by any conventional means such as detents, which require a minimal elastic deformation during installation. As shown, the cupholders 38 are formed from plastic. However, other materials can be used. Any conventional means can be used to form the cupholders 38. The cupholders 38 may also include a means of securing a cup that is to be placed in the cupholder such as a biasing arm or a plurality of resilient members that aid in further securement of the cup.

The storage container 40 may be integrally formed as a part of the convenience unit 14, or may be formed separate to facilitate removal and cleaning of the container 40. When formed separately, the storage container is secured within the unit 14 by any conventional means such as detents, which require a minimal elastic deformation of the container 40 or unit 14 during insertion and removal. The storage container 40 is typically made from a material such as plastic, and can be formed by any conventional means such as injection molding. As shown in FIG. 1, the storage container 40 may be an ashtray, wherein a plastic used to form the ashtray has a high resistance to heat. FIG. 1 illustrates a lid mount 48 as being integrally formed with the storage container 40, but the lid mount 48 may be formed separately and attached to the unit 14. The lid mount 48 allows the lid 16 to be hingedly secured to the storage container 40, and allows the lid 16 to sealingly engage the container 40.

The hinge half 42, as illustrated in FIGS. 2 through 5, is integrally formed as a part of the convenience unit 14, but it is understood the hinge half 42 may be manufactured separately and attached to the unit 14. The hinge half 42 serves as an attachment point for the convenience unit 14 to the housing 12 and allows the convenience unit 14 to pivot from a closed position within the housing 12 to an open position that allows the user of the unit 14 to access the cupholders 38 and storage container 40.

The link arm mount 44, as illustrated in FIGS. 2 through 5, is integrally formed as a part of the convenience unit 14, although the link arm mount 44 may be formed separately from the unit 14 and attached by any conventional means such as fastening. The link arm mount 44 serves as an attachment point for the link arm first end 50, and allows the link arm 18 to rotate around the link arm mount 44.

The latch 46 is disposed in the convenience unit 14, but it is understood the latch 46 may be disposed on other components, such as the housing 12. The latch 46 shown is a slam latch, which allows for self engagement of the latch receiver 30 when the convenience unit 14 is closed. However, other types of latches may be used.

The lid 16 is typically made from a material such as plastic, and can be formed by any conventional means such as injection molding. When the storage container 40 is an ashtray, the plastic used to form the lid 16 has a high resistance to heat. The lid 16 is hingedly attached to the lid mount 48, illustrated in FIGS. 2 through 5. The lid 16 is subject to a biasing force by a spring 52, which causes the lid 16 to remain in an open position unless acted upon by a force to close the lid 16, thereby sealingly engaging the lid 16 with the storage container 40. During movement of the convenience unit 14 to a closed position, the link arm 18 provides the opposing force required to close the lid 16, militating against the spillage of contents of the storage container 40.

Typically, the link arm 18 is made from a material such as plastic, and can be formed by any conventional means such as injection molding. The link arm 18 has a first end 50, a second end 54, a contact region 56, and link arm guides 58. The first end 50 of the link arm 50 is hingedly attached to the convenience unit 14 by any conventional means. The second end 54 of the link arm 18 includes two link arm guides 58, as illustrated in FIGS. 2 through 5, slidably disposed in the elongate apertures 28 of the housing 12, allowing the link arm 18 attachment point at the second end 54 to vary dependent upon the position of the convenience unit 14. The link arm guides 58 are shown as being integrally formed as a part of the link arm 18, but it is understood they may be produced separately from and attached to the link arm 18. The contact region 56 of the link arm 18 includes a cammed surface and contacts the lid 16 at a point intermediate the first end 50 and the second end 54, exerting the required force to close the lid 16 during a movement of the unit 14 from an open position to a closed position. It is understood the contact region 56 is not required to contact the lid 16 when the unit 14 is in an open position, but the embodiment shown displays constant contact between the lid 16 and the contact region 56. The contact region 56 is shown as a contoured surface of the link arm 18, but other surface characterizations may be employed to the same effect, for example a centrally located protuberance. The link arm 18 also serves to dampen the pivotal movement of the convenience unit 14, preventing excessive opening speed and militating against a forceful ejection of the contents of the storage container 40 when the convenience unit 14 reaches the open position. Damping is accomplished by frictional forces created between the link arm guides 58 and the elongate apertures 28.

FIGS. 2 through 5 illustrate the movement of the components of the assembly 10 from an open position to a closed position. FIG. 2 shows the assembly 10 in the open, or in use position. The lid 16 is pivoted away from the storage container 40, thereby allowing the user of the convenience unit assembly 10 to insert contents 60, such as ashes or loose change, into the storage container 40. The contents 60 may reside in the storage container 40 when the assembly 10 is in any position. The open position of the assembly 10 is also suited for the temporal use of the cupholders 38 by the vehicle occupants.

FIG. 3 illustrates the initial movement of the components as the convenience unit 14 is pivoted into a storage position. The pivoting of the convenience unit 14 about the hinge formed by hinge half 26 and hinge half 42 causes the link arm guides 58 to move along the elongate apertures 28, allowing the link arm 18 to maintain a substantially vertical orientation until the lid 16 is closed. The contoured surface of the link arm 18 forces the prompt closure of the lid 16 against the storage container 40.

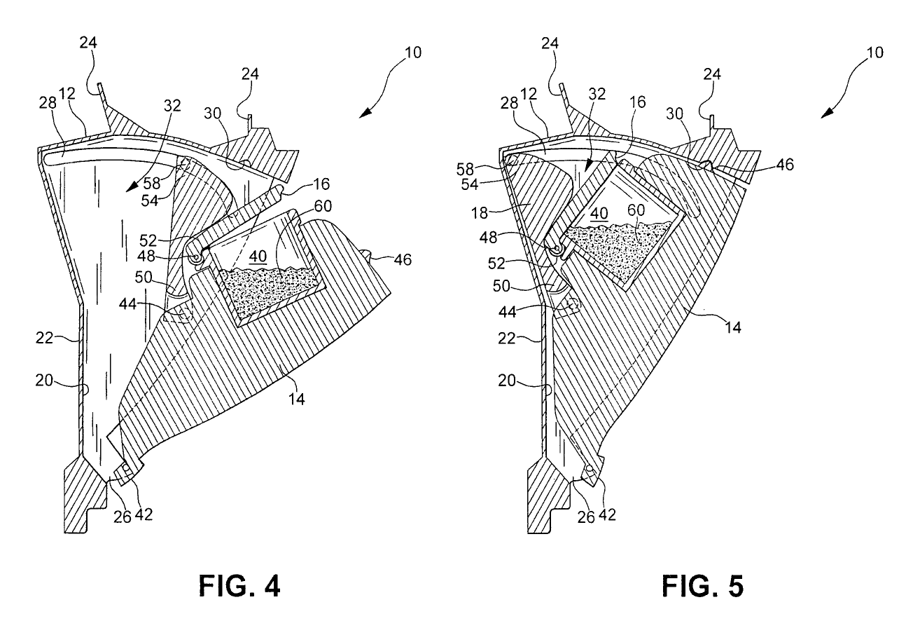

FIG. 4 illustrates the assembly 10 in an intermediate position, where the lid 16 is substantially closed, the convenience unit 14 being approximately half of the way into a storage position. Upon closure of the lid 16, the link arm 18 and convenience unit 14 have a common pivot point, and the link arm guides 58 follow a substantially radial path defined by the elongate apertures 28 about the convenience unit 14 hinge. The closure of the lid 16 militates against spillage of the contents 60 of the storage container 40 by the pivotal movement of the convenience unit 14 and storage container 40. The positioning of the components is maintained through the rest of the movement of the convenience unit 14, as well as when the storage position is reached.

FIG. 5 illustrates the assembly 10 in a closed position, where the latch 46 has engaged the latch receiver 30 and the closure of the lid 16 is secured by the link arm 18. This position is maintained until the user of the device releases the latch 46, allowing the assembly 10 to be released from storage. Upon release, the opposite process from closing the convenience unit 14 is observed, allowing the storage container 40 to open without risk of spillage, where the downward motion of the unit 14 is dampened by frictional forces between the link arm guides 58 and the elongate apertures 28, preventing a forceful ejection of the contents 60 of the container 40 by an abrupt stop at the end of the range of motion of the convenience unit 14

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

What is claimed is:

1. A convenience unit assembly for a vehicle comprising:
a convenience unit hingedly positioned within an interior of the vehicle including at least one cupholder and at least one storage container disposed therein;
a lid hingedly disposed on said convenience unit; and
a link arm having a first end hingedly attached to said convenience unit and a second end slidably disposed in an elongate aperture in said interior of the vehicle, said link arm contacting said lid to close said lid when said convenience unit is pivoted into a closed position and permit said lid to open when said convenience unit is pivoted into an open position.

2. A convenience unit assembly for a vehicle according to claim 1, wherein said link arm closes said lid when said convenience unit is pivoted into the closed position and permit said lid to open when said convenience unit is pivoted into an open position when said convenience unit is substantially in the open position.

3. A convenience unit assembly for a vehicle according to claim 1, wherein said lid sealingly engages the storage container and is urged to the open position by a coil spring.

4. A convenience unit assembly for a vehicle according to claim 1, wherein a point intermediate the attachment points of said link arm contacts said lid to close said lid when said convenience unit is pivoted into the closed position and permits said lid to open when said convenience unit is pivoted into the open position.

5. A convenience unit assembly for a vehicle according to claim 1, wherein said link arm includes a surface acting as a cam against said lid.

6. A convenience unit assembly for a vehicle according to claim 1, wherein the storage container is an ashtray.

7. A convenience unit assembly for a vehicle according to claim 1, wherein the convenience unit assembly is formed by injection molding plastic.

8. A convenience unit assembly for a vehicle according to claim 1, wherein said link arm dampens the pivotal motion of said convenience unit.

9. A convenience unit assembly for a vehicle according to claim 1, wherein said convenience unit assembly is disposed in a dash panel of a vehicle.

10. A convenience unit assembly for a vehicle comprising:
a housing configured to be disposed in an interior of the vehicle, said housing having an elongate aperture formed therein;
a convenience unit hingedly positioned within said housing including at least one cupholder and at least one storage container disposed therein;
a lid hingedly disposed on said convenience unit; and
a link arm having a first end hingedly attached to said convenience unit and a second end slidably disposed in the elongate aperture in said housing, said link arm contacting said lid to close said lid when said convenience unit is pivoted into a closed position and permit said lid to open when said convenience unit is pivoted into an open position when said convenience unit is substantially in the open position.

11. A convenience unit assembly for a vehicle according to claim 10, wherein said lid sealingly engages the storage container and is urged to the open position by a coil spring.

12. A convenience unit assembly for a vehicle according to claim 10, wherein a point intermediate the attachment points of said link arm contacts said lid to close said lid when said convenience unit is pivoted into the closed position and permits said lid to open when said convenience unit is pivoted into the open position.

13. A convenience unit assembly for a vehicle according to claim 10, wherein the convenience unit assembly is formed by injection molding plastic.

14. A convenience unit assembly for a vehicle according to claim 10, wherein said link arm dampens the pivotal motion of said convenience unit.

15. A convenience unit assembly for a vehicle according to claim 10, wherein said housing is disposed in a dash panel of the vehicle.

16. A convenience unit assembly for a vehicle comprising:
a housing configured to be disposed in an interior of the vehicle, said housing having an elongate aperture formed therein;
a convenience unit hingedly positioned within said housing including at least one cupholder and at least one storage container disposed therein;
a lid hingedly disposed on said convenience unit; and
a link arm having a first end hingedly attached to said convenience unit and a second end slidably disposed in the elongate aperture in said housing acting to dampen the pivotal speed of said convenience unit, said link arm contacting said lid to close said lid when said convenience unit is pivoted into a closed position, wherein a point intermediate the attachment points of said link arm contacts said lid and permits said lid to open when said convenience unit is pivoted into an open position when said convenience unit is substantially in the open position.

17. A convenience unit assembly for a vehicle according to claim 16, wherein said lid sealingly engages the storage container and is urged to the open position by a coil spring.

18. A convenience unit assembly for a vehicle according to claim 16, wherein the storage container is an ashtray.

19. A convenience unit assembly for a vehicle according to claim 16, wherein said convenience unit assembly is formed by injection molding plastic.

20. A convenience unit assembly for a vehicle according to claim 16, wherein said housing is disposed in a dash panel of the vehicle.
